(19) United States
(12) Patent Application Publication
(10) Pub. No.: US 2021/0251725 A1
(43) Pub. Date: Aug. 19, 2021

(54) Removable Decorative Frame for Orthodontic Bracket

(71) Applicant: Kolton K. Erickson, Edmond, OK (US)

(72) Inventor: Kolton K. Erickson, Edmond, OK (US)

(21) Appl. No.: 16/791,184

(22) Filed: Feb. 14, 2020

(51) Int. Cl. A61C 7/16

(52) U.S. Cl. CPC A61C 7/16; A61C 2201/002

(57) ABSTRACT

An accessory device for an orthodontic bracket for easy, consumer tool-free attachment and detachment to and from a bracket mounted on a tooth, having a decorative frame with three or more substantially straight members arranged at orthogonal angles; a retention frame with at least two substantially straight members substantially parallel to at least two of the decorative frame members; and one or more spacer member extending between the decorative frame and the retention frame; thereby defining at least one substantially rectangular parallelepiped within the decorative frame, retention frame and spacer member for slidably receiving an orthodontic bracket through an opening in the retention frame, wherein the retention frame engages a tooth base of an orthodontic bracket, and wherein the decorative frame provides a decorative coating, color, shape, pattern, surface treatment, or combination thereof.

### FIELD OF THE INVENTION

This invention relates to attachments for orthodontic braces for the purposes of increasing patient compliance with orthodontic treatment regimens.

### BACKGROUND OF THE INVENTION

Orthodontic braces provide for useful therapy to realign a patient's teeth to improve the functioning of occlusion as well as to improve the appearance of the patient's smile. There are many benefits of braces, including, but not limited to, improvement of ability to chew food; alleviation of speech impairment; improvement of ability to brush, clean and floss teeth; reduction of cavities and periodontal disease; reduction of grinding and chipping of teeth; and reduction of risk of injury from protruding teeth.

However, the appearance of the braces themselves may be undesirable to some patients, and due to their highly mechanical appearance, may discourage patient compliance with the orthodontic treatment plan.

### SUMMARY OF THE DISCLOSED EMBODIMENT(S)

Disclosed are one or more embodiments according to the present invention of an accessory device for an orthodontic bracket for easy, consumer tool-free attachment and detachment to and from a bracket mounted on a tooth, having a decorative frame with three or more substantially straight members arranged at orthogonal angles; a retention frame with at least two substantially straight members substantially parallel to at least two of the decorative frame members; and one or more spacer member extending between the decorative frame and the retention frame; thereby defining at least one substantially rectangular parallelepiped within the decorative frame, retention frame and spacer member for slidably receiving an orthodontic bracket through an opening in the retention frame, wherein the retention frame engages a tooth base of an orthodontic bracket, and wherein the decorative frame provides a decorative coating, color, shape, pattern, surface treatment, or combination thereof.

### BRIEF DESCRIPTION OF THE DRAWINGS

The description of exemplary embodiments of the invention as set forth herein are illustrated by the drawings.

FIG. 1 illustrates a perspective view of a shaped wire attachment for decorative adornment to an orthodontic bracket.

FIG. 2 illustrates a view from the left side of the view of FIG. 1.

FIG. 3 illustrates a view from the right side of the view of FIG. 1.

FIG. 4 illustrates a view from the front of the view of FIG. 1.

FIG. 5 illustrates a view from rear of the view of FIG. 1.

FIG. 6 illustrates a view from the top of the view of FIG. 1.

FIG. 7 illustrates a view from bottom of the view of FIG. 1.

FIG. 8 illustrates installation of the example embodiment of FIG. 1 onto an example bracket.

FIG. 9 illustrates the example embodiment as installed onto an example bracket.

FIG. 10 illustrates another embodiment 100′ according to the present invention.

### DETAILED DESCRIPTION OF ONE OR MORE EXEMPLARY EMBODIMENT(S) OF THE INVENTION

The inventor has realized a need in the art which remains unsatisfied with respect to decorative adornments for orthodontic braces, and especially the brackets which are already affixed to the patient's teeth. Prior to the shift to self-ligating brackets, the use of elastomeric ligatures with decorative colors was popular.

However, as discussed in “Possible Advantages of Self-Ligating Brackets: From Claims to Evidence” by Homa Farhadifard, et al., there are many benefits of using self-ligating brackets (SLBs) which do not use elastometeric ligatures or wire to engage the archwire in the bracket slot. Among these advantages can be lower resistance to sliding of the bracket along the archwire which speeds tooth movement and therapy results; reduced pain to the patient during treatment; better quality of alignment; and speed of installing and adjusting the archwire in each bracket. While Farhadifard found that some study results on these advantages contradicted each other, the perception and belief in self-ligating brackets' advantages persists among orthodontists and their patients.

However, with the elimination of elastomeric ligatures which led to the elimination of decorative color options, this is no longer an option to improve patient zo willingness to engage and comply with an orthodontic treatment plan. Decorative attachments for self-ligating brackets presently on the market are difficult to attach and detach, so they require a visit to an orthodontist's office for professional installation and removal. This precludes changing of the appearance of the braces on the patient's own schedule, such as putting team colors onto the brackets for an evening of a big high school sports game, and then switching them out for less bright colors for a formal occasion, such as attending a ceremony.

Further, many of these available decorative attachments for SLBs are designed only to attach to one type of self-ligating bracket or another, but do not provide a universal fit for application across all known bracket types or at least across a limited rage of bracket types.

Still further, many of the available decorative attachments for SLBs actually engage and put pressure on the archwire, bracket, or both, which may undermine the very benefits of SLBs compared to conventional brackets (CBs).

Therefore, there is a need in the art for a decorative adornment for common orthodontic braces which is amenable to attachment and detachment by patients, which potentially fit a wide variety of braces bracket designs, and which attach to a CB or SLB in a manner which does not place force on the archwire or the bracket that would affect operation of the orthodontic system nor cause pain or discomfort to the wearer.

### Braces Brackets Types

There are a number of different types of orthodontic brackets available and in use today, including ceramic brackets, cobalt chromium brackets, composite brackets, zo gold brackets, lingual brackets, plastic brackets, self-ligating brackets, stainless steel brackets, and titanium brackets. While their mechanisms and shapes to receive and hold an archwire vary, the present inventor has observed that most of generally rectangular in the shape that contacts the tooth surface, and many of them are generally rectangular parallelepipeds.

### A First Shaped Wire Embodiment Example

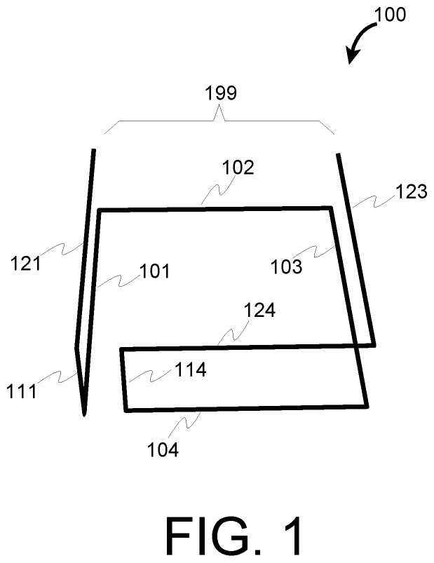

Referring now to FIG. 1, a perspective view of a shaped wire attachment 100 for decorative adornment to an orthodontic bracket is shown. In this example embodiment, the attachment is formed by bending or shaping a single piece of wire which preferably is made of a medical-grade metal, exhibits strong shape memory properties so that it can be stretched or twisted slightly for installation and removal, and is provided with a decorative color treatment on at least the most visible portions, and preferably, over the entire device.

The overall device 100 defines an outline of a substantially rectangular parallelepiped, minus at least one long edge and two adjacent short edges, which provides a gap 199 in the device for receiving an orthodontic bracket and an archwire into the volume defined by the segments. A decorative frame, which will be most visible near edges of a bracket farthest away from the tooth, is created by three or more segments 101, 102, 103 and 104, which are substantially straight segments and attached to each other by substantially right angle bends. A retention frame for surrounding the received bracket near the interface between the foot of the bracket and the tooth surface is created by two or more substantially straight segments, such as zo three segments 121, 123 and 124, and are attached to each other by a plurality of substantially right angle bends, including at least one spacer member, such as two spacer members 111 and 114, which extend between the decorative frame 101, 102, 103 and 104 and the retention frame 121, 123 and 124.

While several bending patterns are available within the scope of the present invention, the pattern illustrated in FIG. 1 provides for a minimum number of bends during with a large degree of flexibility for easiest installation and removal.

Please note that, by “substantially straight segments”, we are referring to segments which may be slightly bent or curved to provide for desired spring characteristics. By “substantially right angle bends”, we are referring to corners formed in the device which are generally 90 degrees, but which may be over-bent (less than 90 degrees) or under-bent (greater than 90 degrees) in order to provide for desired spring characteristics. And, by “a substantially rectangular parallelepiped”, we are referring to a generally rectangular shape the edges of which are substantially parallel, more or less, in order to provide for desired spring characteristics.

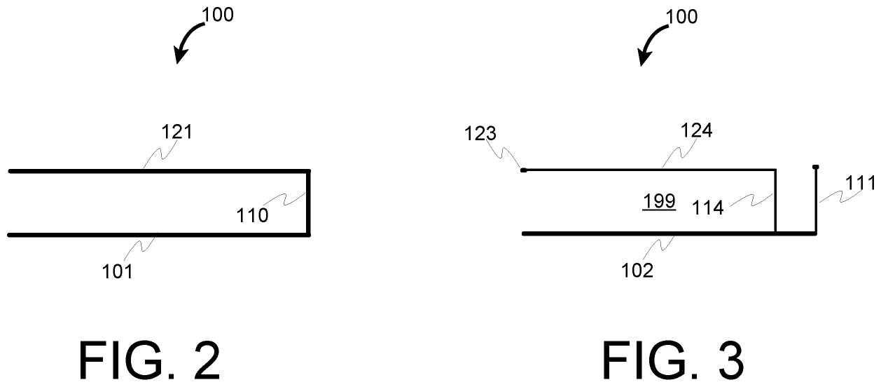

FIG. 2 provides a straight-on view from the left side of the perspective view of FIG. 1, while FIG. 3 provides a straight-on view from the right side of the perspective view of FIG. 1, in which visible wire segments that are farther back are shown in thinner (less weight) lines, and visible wire segments that are closer are shown in wider (more weight) lines.

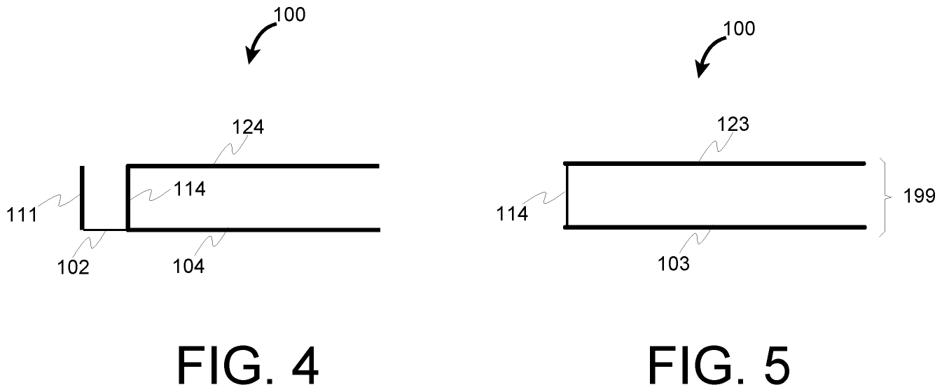

FIG. 4 provides a straight-on view from the front of the perspective view of FIG. 1, while FIG. 5 provides a straight-on view from rear of the perspective view of FIG. 1, in which visible wire segments that are farther back are shown in thinner (less weight) zo lines, and visible wire segments that are closer are shown in wider (more weight) lines.

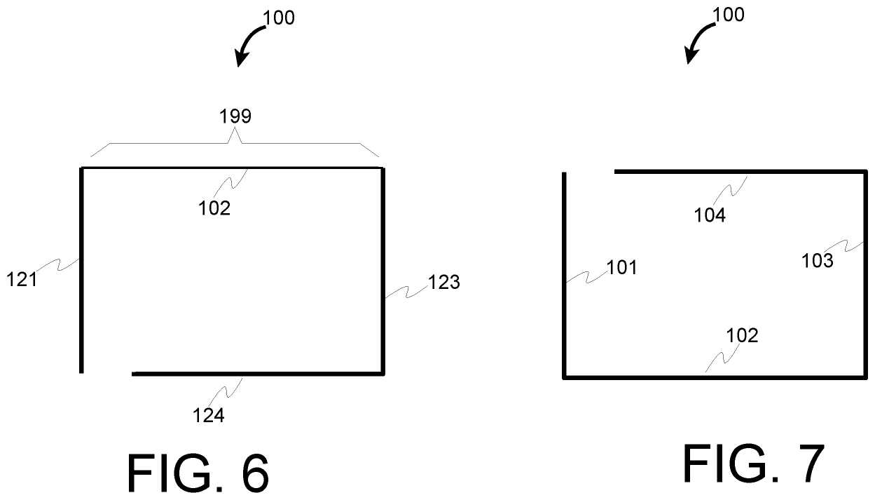

FIG. 6 provides a straight-on view from the top of the perspective view of FIG. 1, while FIG. 7 provides a straight-on view from bottom of the perspective view of FIG. 1, in which visible wire segments that are farther back are shown in thinner (less weight) lines, and visible wire segments that are closer are shown in wider (more weight) lines.

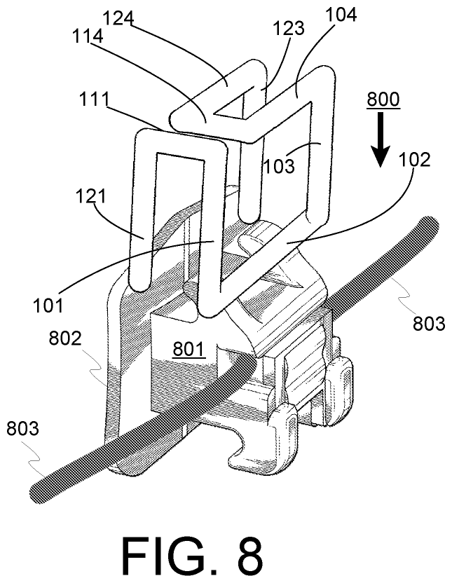

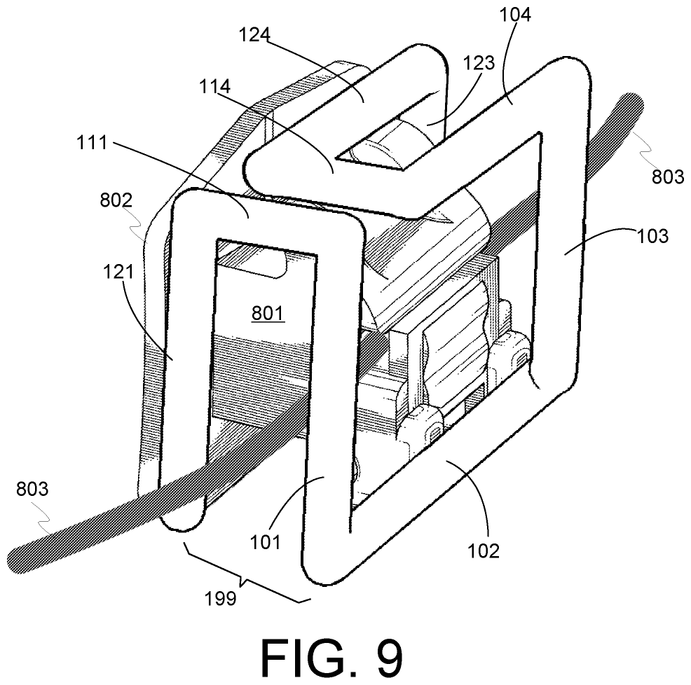

FIG. 8 provides a view of the example embodiment being slidably installed 800 on an example bracket such as the bracket disclosed in U.S. Pat. No. 6,071,118 to Dwight H. Damon (issued Jun. 6, 2000) 801 with a base 802 that attaches to a patient's tooth. Installation is simple by sliding 800 the device down along the tooth surface and slightly above the base 802 such that the bracket 801 and the archwire 803 pass through the opening 199 in the retention frame 121 and 123, thereby positioning the decorative frame 101, 102, 103 and 104 around the edges of the bracket 801 farthest from the tooth surface and from the bracket base 802, where the decorative frame 101, 102, 103 and 104 will be most visible, as shown in FIG. 9. As can be seen from these two figures, the opening 199 serves both as a passage way to receive the bracket 801 as well as a passage way to receive the archwire 803, thereby eliminating the need to install the decorative device before the archwire is installed or while the archwire is removed, which would otherwise require professional skills and tools to accomplish.

As the wire material used to fabricate the device preferably has a strong shape memory, it can be formed in a manner which is stretchable to widen the opening to ease installation, and upon releasing it, it returns to a slightly smaller geometry, clamping onto and around the bracket for secure retention on the bracket. Removal of the device is equally simple by slightly stretching the device to widen the opening, and lifting or zo sliding it vertically along the tooth surface to withdraw the bracket from the volume defined by the device. In this manner, the decorative accessory device of this example embodiment securely and easily attaches and detaches from a wide variety of orthodontic bracket types, without requiring orthodontic technician skills or tools, without requiring twisting and untwisting of wires, and without snapping onto or putting any pressure on the archwires which could interfere with the alignment action of or damage the orthodontic appliance. It should be noted that other embodiments with fewer or more pieces, elements, and components, are available within the spirit and the scope of the present design. It should also be noted that some embodiments may include a variety of components and materials, such as, but not limited to, a plastic decorative frame with a bent-wire retention frame. Additional bends may be incorporated into some embodiments to provide for more secure retention, as well.

### A Second Shaped Wire Embodiment Example

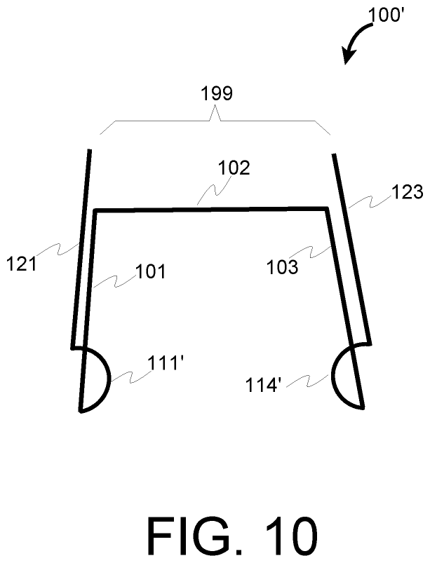

Referring now to FIG. 10, an example embodiment having a three-sided decorative frame 101, 102 and 103, with modified spacer members 111′ and 114′ that also serve as a détente to stop the device from sliding too far onto a bracket, and a two-member retention frame 121 and 123. In this embodiment, the gap 199 for receiving both the bracket and the installed archwire is also provided for convenient installation and removal without the need for removing the archwire.

### Preferred Materials

For the mechanical elements of the various embodiments of the invention, there is a wide array of suitable non-toxic materials which provide the desired shape memory, and which can take a coating for decorative color. In some embodiments, plastic, such as molded plastic may be used instead of wire, while in other embodiments, wire may be formed by heating or bending into a shape according to the present invention. Stainless steel or Nickel titanium (Nitinol) alloy wire are preferable choices, such as Nitinol 55 and Nitinol 60, for their superior shape memory and elasticity. Wires made of other metals and alloys may also be suitable for other embodiments of the present invention, so long as the usual considerations regarding health, sensitivity, dissimilar metal reactions, durability, and safety are met.

For the decorative color and/or patter on at least the decorative frame portion, and potentially on the entire device, various non-toxic durable paints, inks, heat treatments, electroplating and coatings may be applied to the Nitinol wire can be applied before or after forming it into the desired shape, such as those reviewed by Arango, et al., in “Coating and Surface Treatments on Orthodontic Metallic Materials” (Coatings journal, 2013, vol. 3, pages 1-15), including, but not limited to, epoxy paints, polytetrafluoroethylene (PTFE) (e.g., Teflon™), electrostatic powder, thermal plasma spray (TPS), chemical vapor deposition (CVD), physical vapor deposition (PVD), evaporation, physical sputtering, electrodeposition, and sol-gel method.

### Conclusion

The terminology used herein is for the purpose of describing particular embodiments only and is not intended to be limiting of the invention. As used herein, the zo singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless specifically stated otherwise.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. An accessory device for attachment and detachment to an orthodontic bracket mounted on a tooth, comprising:
a decorative frame having three or more substantially straight members arranged at orthogonal angles;
a retention frame having at least two substantially straight members substantially parallel to at least two of the decorative frame members; and
at least one spacer member extending between the decorative frame and the retention frame;
thereby defining at least one substantially rectangular parallelepiped within the decorative frame, retention frame and spacer member for slidably receiving an orthodontic bracket through an opening in the retention frame, wherein the retention frame engages a tooth base of an orthodontic bracket, and wherein the decorative frame provides a decorative coating, color, shape, pattern, surface treatment, or combination thereof.

2. The accessory device as set forth in claim 1 wherein at least the retention frame is zo fabricated of a material having shape memory whereas the retention frame can be stretched to widen the opening for allowing slidable installation and slidable removal of the accessory device to and from the orthodontic bracket.

3. The accessory device as set forth in claim 2 wherein material comprises wire.

4. The accessory device as set forth in claim 3 wherein the wire comprises a metal selected from the group consisting of stainless steel wire and nickel titanium alloy wire.

5. The accessory device as set forth in claim 1 wherein decorative frame is provided with at least one decorative element selected from the group consisting of an epoxy paint, a polytetrafluoroethylene coating, a deposited electrostatic powder, a thermal plasma spray coating, a chemical vapor deposition coating, a physical vapor deposition coating, a surface treatment through evaporation, a surface treatment through physical sputtering, a surface treatment through electrodeposition, and a surface treatment through sol-gel method.

6. A method for manufacturing an accessory device for attachment and detachment to a orthodontic bracket mounted on a tooth, comprising:
forming a decorative frame having three or more substantially straight members arranged at orthogonal angles;
forming a retention frame having at least two substantially straight members substantially parallel to at least two of the decorative frame members; and
disposing at least one spacer member extending between the decorative frame and the retention frame;
thereby defining at least one substantially rectangular parallelepiped within the decorative frame, retention frame and spacer member for slidably receiving an orthodontic bracket through an opening in the retention frame, wherein the retention frame engages a tooth base of an orthodontic bracket, and wherein the decorative frame provides a decorative coating, color, shape, pattern, surface treatment, or combination thereof.

7. The method as set forth in claim 6 wherein at least the retention frame is fabricated of a material having shape memory whereas the retention frame can be stretched to widen the opening for allowing slidable installation and slidable removal of the zo accessory device to and from the orthodontic bracket.

8. The method as set forth in claim 7 wherein material comprises wire.

9. The method as set forth in claim 8 wherein the wire comprises a metal selected from the group consisting of stainless steel wire and nickel titanium alloy wire.

10. The method as set forth in claim 6 further comprising providing to at least the decorative frame at least one decorative element selected from the group consisting of an epoxy paint, a polytetrafluoroethylene coating, a deposited electrostatic powder, a thermal plasma spray coating, a chemical vapor deposition coating, a physical vapor deposition coating, a surface treatment through evaporation, a surface treatment through physical sputtering, a surface treatment through electrodeposition, and a surface treatment through sol-gel method.
